(19) United States
(12) Patent Application Publication
(10) Pub. No.: US 2013/0121832 A1
(43) Pub. Date: May 16, 2013

(54) Wind Turbine with Cable Supported Perimeter Airfoil

(71) Applicant: Gerald L. Barber, Greenville, SC (US)

(72) Inventor: Gerald L. Barber, Greenville, SC (US)

(21) Appl. No.: 13/294,572

(22) Filed: Nov. 11, 2011

(51) Int. Cl. F03D 1/06

(52) U.S. Cl. 416/179

(57) ABSTRACT

A wind turbine 10 includes a turbine wheel 14 that includes a circular air foil 22 surrounding the turbine blades 24, with the angle of attack 39 of the air foil directing some of the trailing air outwardly in a cone-shaped path to form an area of low air pressure that induces more rapid flow of atmospheric air through the turbine blades.

### FIELD OF THE INVENTION

This invention concerns a wind driven turbine for the generation of electricity that includes a turbine wheel rotatably mounted on a laterally extending central axis, with an electrical generator in driven relationship with the turbine wheel.

### BACKGROUND OF THE INVENTION

Windmills have been used for many generations for the purpose of pumping water from the ground and for generating electricity. The basic advantage of the windmill is that it uses the power of the wind to move the blades. This rotary movement is converted into various useful purposes. For example, wind turbines including turbine blades mounted on towers have been placed in areas where steady winds are prevalent and the rotary movements of the wind driven turbine blades are used to generate electricity.

In order to take maximum advantage of the wind energy, the blades of the conventional wind turbines are very large and must be made of expensive rigid material, with no extra support at the outer tips of the blades. The conventional wind turbine blades rotate at a high rate of revolutions and must withstand both the centrifugal forces generated by the fast revolution of the blades and the cantilever bending forces applied to the blades by the wind. Since the outer portions of the blades move at a very high velocity and are engaged by strong winds, the larger the blades the stronger they must be and the more expensive they become. Thus, there is a practical limit as to the length and width of the turbine blades.

Another wind turbine concept is disclosed in U.S. Patent Publications 2010/0266407 A1 and 2010/0264663 A1. These wind turbines have a turbine wheel that includes an elongated central axle structure and an outer concentric circular rail, and support cables extend radially form the ends of the axle structure and converge inwardly toward connection with the outer concentric rail, similar to the conventional bicycle wheel. In this way, the outer concentric circular rail is firmly yet rotatably supported in its concentric relationship with the central axle structure. Turbine blades extend radially between and are supported at their ends by the central axle structure and the outer concentric circular rail. With this construction the turbine blades are not self-supportive at their outer ends, but are supported at their ends by the central axle structure and the outer concentric circular rail.

The outer concentric circular rim supports the outer portions of the turbine blades so that the force of the wind applied to the blades may be absorbed to a major extent by the outer rim so there is little if any cantilever force applied to the blades. This allows the blades of the wind turbine to be formed of lighter weight material, material that is not required to bear as much stress in comparison to the typical free bladed turbine. This also allows the use of turbine blades that may be much longer than the blades of conventional prior art wind turbines.

An electrical generator may be mounted to the turbine wheel, such as to the outer concentric circular rail to generate electricity in response to the atmospheric wind engaging the blades and rotating the turbine wheel.

In addition to the above noted recent developments, it would be desirable to increase the effective forces of the atmospheric winds against the turbine blades of a wind turbine, particularly in slow wind conditions. For example, the prior art teaches the use of a shroud mounted about the turbine blades of a wind turbine that develops a zone of high velocity wind at the blades of the wind turbine to form a greater air pressure differential across the blades of the wind turbine. See U.S. Patent Publications 2020/0308595 A1, 2011/0085901 A1, and U.S. Pat. No. 6,849,965 B2. However, the shrouds add to the weight of the overall structures and it appears that the turbine blades are of conventional short and heavy cantilever designs and do not have the blade length for higher performance.

Thus, it would be desirable to produce and use a wind turbine that has light weight long turbine blades and includes a means for inducing a zone of low pressure air at or behind the turbine blades for increasing the pressure differential across the blades, thereby enabling the wind turbine to be more efficient, particularly during low wind conditions.

### SUMMARY OF THE DISCLOSURE

Briefly described, this disclosure sets forth the features of a wind turbine that is powered by atmospheric wind and which can be used to create rotary energy that is transformed into an end product, such as to drive an electrical generator, to run a grist mill, or to pump water. The end use may vary in accordance with need, but a practical end use for the wind turbine is to create electricity by driving a generator.

A turbine wheel is mounted on a mast or other turbine wheel support for generating power by rotating in response to oncoming atmospheric wind. The turbine wheel includes a central axle structure for mounting on the turbine wheel support, a perimeter rim extends coaxially about the central axle structure and rotates about the central axle structure. An airfoil is mounted to the perimeter rim and is rotatable with the perimeter rim about the central axle structure.

A plurality of turbine blades are mounted in the turbine wheel and each blade includes an inner end supported by the central axle structure and an outer end supported by the perimeter rim.

A plurality of cables extend between the central axle structure and the perimeter rim and support the perimeter rim from the central axle structure such that said perimeter rim is rotatable about said central axle structure.

The air foil is shaped to redirect the atmospheric wind in an outwardly directed approximately conical shape extending downstream from the central axle structure for forming a reduced atmospheric air pressure downstream of the airfoil for enhancing the movement of atmospheric air through the plurality of turbine blades.

The perimeter rim may extend radially outwardly from the air foil, and an electrical generator may be positioned at the perimeter rim for converting the rotatory movements of the perimeter rim into electricity.

The central axle structure of the turbine wheel supports the turbine wheel on a horizontal axis and the turbine wheel is movable on the turbine wheel support about a vertical axis to face the changing directions of oncoming wind.

The airfoil may be connected to the perimeter rim and move in unison with the perimeter rim. The air foil may be formed of a series of air foil segments extending about the perimeter rim.

Other objects, features and advantages of this invention may be understood upon reviewing the accompanying drawings when taken in conjunction with the following specification and claims.

### BRIEF DESCRIPTION OF THE DRAWINGS

FIG. 1 is a front elevational view of the wind turbine, showing the turbine wheel mounted on a vertical mast.

FIG. 2 is a side elevational view, showing the mast and turbine wheel with the airfoil shown in cross section.

FIG. 3A is a top view of the turbine wheel and its mast, showing the airfoil in cross section.

FIG. 3B is a side elevational view of the wind turbine, showing the airfoil in cross section.

FIG. 4 is a schematic illustration of the airfoils of the turbine wheel, showing how the oncoming wind moves about the airfoils and is redirected to form a zone of reduced air pressure downstream of the airfoils.

FIG. 5 is a partial view of the perimeter rim and the airfoils at the outer edge of the turbine wheel.

FIG. 6 is a detail showing the structure of one of the airfoils and the manner in which it is mounted to the perimeter rim, showing how the direction of the oncoming atmospheric wind is redirected by the airfoil.

FIG. 7 is a side elevational view of the lower portion of the turbine wheel, with an indication of the oncoming atmospheric wind passing about the airfoil, showing how the wind is redirected by the airfoil.

### DETAILED DESCRIPTION

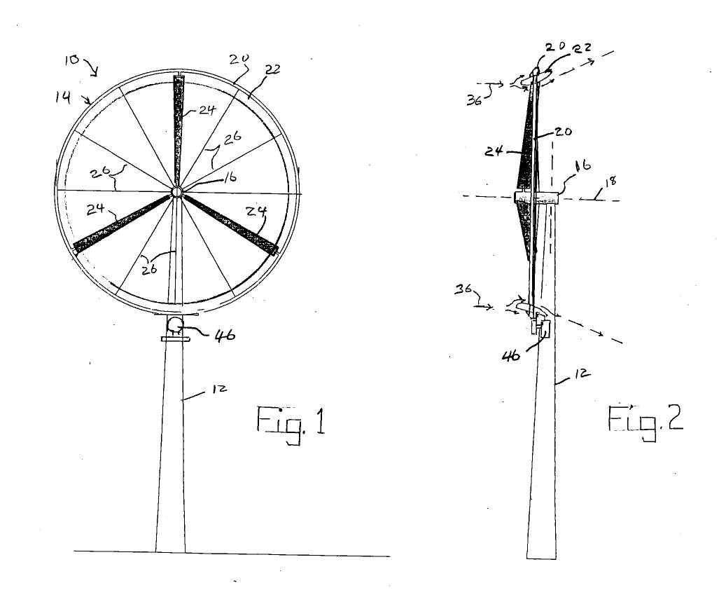

Referring now in more detail to the drawings in which like numerals indicate like parts throughout the several views, FIG. 1 illustrates a wind turbine 10 that includes a vertically oriented mast 12 and a turbine wheel 14 mounted to the mast. The mast 12 functions as a turbine wheel support.

The turbine wheel includes a central axle structure 16 that is supported by the mast 12, with the central axle structure being horizontally oriented and rotatable about a horizontal axis 18.

Turbine wheel 14 includes a circular turbine blade support ring 19 extending concentrically about and rotatable about said central axle structure. The circular turbine blade support ring 19 includes perimeter rim 20 that extends coaxially about the central axle structure 16 and that is rotatable about the central axle structure 16, and circular airfoil 22 mounted inwardly of perimeter rim 20 and also extending circumferentially about said central axle structure. A plurality of turbine blades 24 extend radially from the central axle structure 16 to the circular turbine blade support ring 19. The turbine blades 24 are supported at their inner ends by the central axle structure 16 and at their outer ends by the circular turbine blade support ring 19.

While only three turbine blades 24 are illustrated in FIGS. 1 and 2, a different number of turbine blades may be positioned in the turbine wheel, such as four, five or six turbine blades, as may be desired. Three turbine blades are illustrated so as to better describe the features of the turbine wheel.

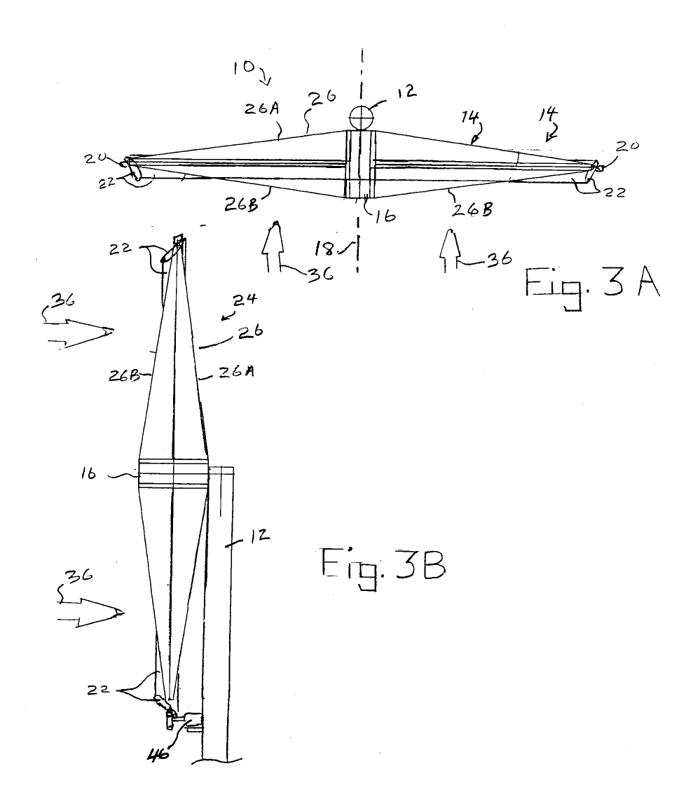

As shown in FIGS. 1, 3A and 3B, the turbine wheel includes a plurality of radially extending cables 26, generally equally angularly spaced about the turbine wheel, extending from the central axle structure 16, radially outwardly to the turbine blade support ring 19. As shown in FIGS. 3A and 3B, there are two sets of cables 26, with one set of cables 26A positioned on one side of the turbine wheel and the other set of cables 26B positioned on the opposite side of the turbine wheel. The cables 26A and 26B have their inner ends mounted to the ends of the central axle structure 16 so that they are spread apart along the axis 18 of the turbine wheel 14. The cables 26A and 26B then converge toward one another as they extend radially outwardly from the central axle structure 16 and are connected at their outer ends to the turbine blade support ring 19. This converging relationship between the cables 26A and 26B forms a stable support for turbine blade support ring 19, holding the turbine blade support ring 19 in a coaxial relationship with respect to the central axle structure 16. Therefore, the turbine blade support ring 19 is firmly supported in its coaxial relationship with respect to the central axle structure 16.

Airfoil 22 is a part of turbine blade support ring 19 and is a circular structure that is also coaxial with respect to the central axle structure 16. Airfoil 22 is joined to the perimeter rim 20 and to the turbine cables 26. Accordingly, airfoil 22 rotates in unison with turbine wheel 14 about central axle structure 16, as will be described in more detail hereinafter.

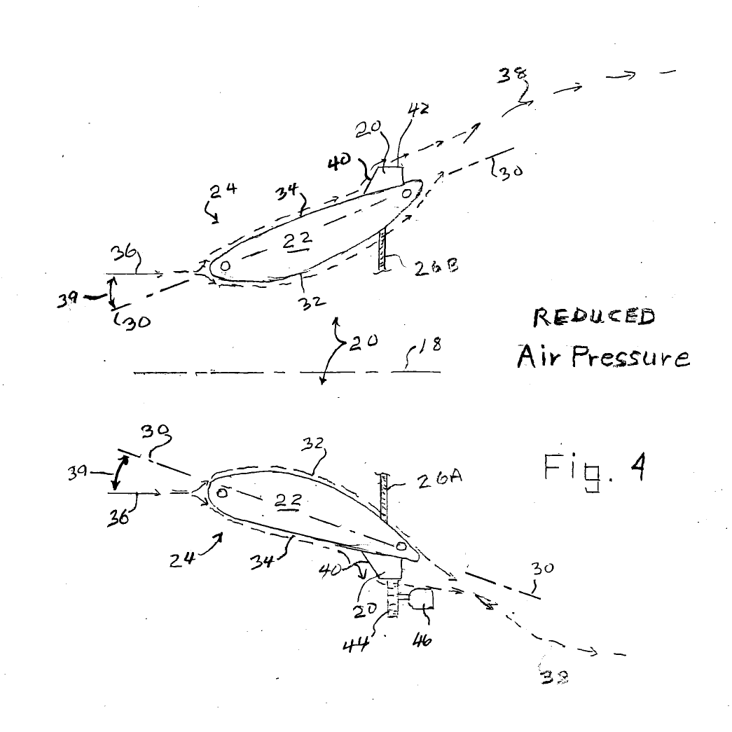

FIG. 4 shows a schematic view of the airfoil, with the airfoil shown in two cross sections that are closely spaced to one another. The airfoil 22 has a longitudinal axis 30, an inwardly facing lift surface 32, and an outwardly facing stable surface 34. Generally, the stable surface 34 is closer to being parallel to the longitudinal axis 30 than the lift surface 32. The lift surface is convex and requires a more radical change of direction of the atmospheric wind flowing about the airfoil, as shown by the dash lines passing over the surfaces.

The atmospheric wind 36 moves toward the front edge of the turbine blades 24 and travels across the lift surface 32 and stable surface 34 as shown by the dash lines of FIG. 4.

The longitudinal axis 30 of the air foil 22 is oriented at an angle of attack 39 with respect to the direction of the on-coming atmospheric wind 36. The angle of attack 39 typically will be approximately 20° from the direction of the oncoming atmospheric wind 36.

It can be seen from the trailing wind direction illustrated at 38 that a substantial redirection of the atmospheric wind takes place as the wind travels across the airfoil 22. This redirection of the atmospheric air induces a reduced air pressure at and behind the perimeter rim 20. The reduced air pressure at and behind the turbine wheel tends to increase the velocity of the oncoming atmospheric air.

As shown in FIG. 4, perimeter rim 20 may protrude radially outwardly from the airfoil 22, and the perimeter rim includes a sloped forwardly facing surface 40, and an outwardly facing horizontal surface 42. The sloped forwardly facing surface 40 is shaped so as minimize the disturbance of the flow of the atmospheric air passing about the airfoil 22. The outwardly facing horizontal surface 42 is shaped so as to be conveniently engaged by the wheel 44 of an electrical generator 46. As shown in FIGS. 1, 2 and 3B, the electrical generator and its wheel may be supported by the upright mast 12.

As the turbine wheel rotates the turbine blades 24, the turbine wheel develops centrifugal forces, but the circular shape of the turbine blade support ring 19, including its perimeter ring 20 and air foil 22, bear most of the centrifugal forces instead of the turbine blades. This allows the use of increased dimensions and weights of the turbine blades. The centrifugal force tends to increase the stability of the overall turbine wheel and also increase the effective strength that supports the turbine blades, adding to the possible dimensions and weights of the turbine blades in high atmospheric wind conditions.

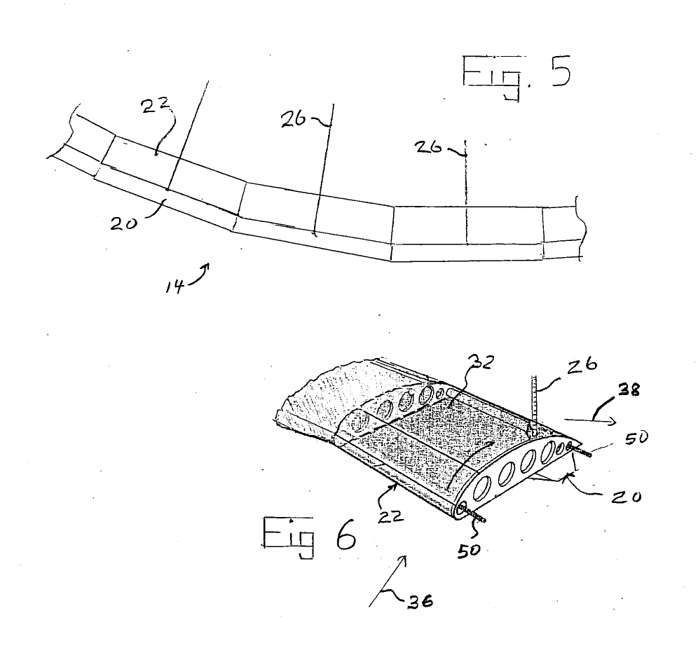

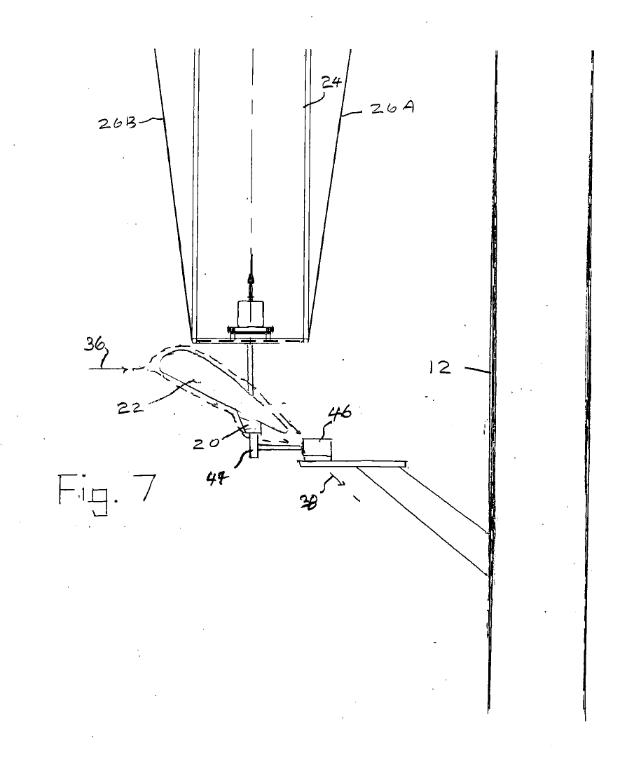

As shown in FIGS. 5 and 6, the airfoil 22 may be formed of rectilinear segments connected end to end. The segments illustrated in FIG. 6 are rectilinear; however, airfoil segments may be made in arcuate segments. Also, like the air foil, the perimeter rim 20 may be made in rectilinear segments or arcuate segments, as may be desired. An advantage of making the perimeter rim and airfoil in segments is that they may be shipped across interstate highways from manufacturing site to the destination where they will be erected for operation.

As shown in FIG. 6, connecting cables 50 may be used to connect the segments of the airfoil 22 together. Other connection means such as cables, bolts, brackets or other connection means may be used as desired. Likewise, similar connecting cables, bolts, or other connection means may be used to connect the segments of the perimeter rim 20 together.

The air foil 22 may be hollow with spars and other conventional interior structural means, as is conventional in the art.

The turbine blades may be made of fiberglass, polyvinylchloride, woven fabric or other materials suitable for the predicted atmospheric conditions, and that hold their shapes over an extended time use.

The cables 26 may be made of various metal materials or non-metal materials. The expression “cables” is to include other structures, preferably of light weight material, that function in tension to hold the turbine blade support ring in place, such as rods or spokes under tension.

It will be understood by those skilled in the art that while the foregoing description sets forth in detail preferred embodiments of the present invention, and modifications, additions, and changes might be made thereto without departing from the spirit and scope of the invention, as set forth in the following claims.

1. A turbine wheel for mounting on a turbine wheel support for generating power from rotating in response to oncoming atmospheric wind, comprising;
a central axle structure for mounting on said turbine wheel support,
a perimeter ring extending coaxially about said central axle structure and rotatable about said central axle structure,
an airfoil mounted to said perimeter rim and rotatable with said perimeter ring about said central axle structure,
a plurality of turbine blades each including an inner end supported by said central axle structure and extending outwardly from said central axle structure toward said perimeter ring and including an outer end supported by said perimeter ring,
a plurality of cables extending between said central axle structure and said perimeter ring and supporting said perimeter ring from said central axle structure such that said perimeter ring is rotatable about said central axle structure,
said air foil shaped to redirect the atmospheric wind in an outwardly directed approximately conical shape extending downstream from said central axle structure for forming a reduced atmospheric air pressure downstream of said airfoil for increasing the speed of atmospheric air through the plurality of turbine blades.

2. The wind turbine of claim 1, wherein said perimeter ring extends radially outwardly from said air foil, and an electrical generator positioned at said perimeter ring for converting the rotatory movements of said perimeter ring into electricity.

3. The wind turbine of claim 2, wherein said central axle structure supports said turbine wheel on a horizontal axis and said turbine wheel is movable on the turbine wheel support about a vertical axis to face the changing directions of oncoming wind.

4. The wind turbine of claim 1, wherein said airfoil is connected to said perimeter ring and moves in unison with said perimeter ring.

5. The wind turbine of claim 1, wherein said air foil is formed of a series of air foil segments extending about said perimeter ring.

6. The wind turbine of claim 5, wherein said air foil is formed in a series of air foil segments in a circular array and each air foil segment including a convex lift surface facing said central axle structure of said turbine wheel and a longitudinal axis oriented at an angle that converges toward the central axis of said turbine wheel.

7. A turbine wheel for mounting on a turbine wheel support for generating power from rotating in response to oncoming atmospheric wind, comprising;
a central axle structure extending horizontally from said turbine wheel and mounting said turbine wheel to said turbine wheel support about a horizontal axis,
a turbine blade support ring mounted concentrically about said central axle structure and rotatable about said central axle structure, said turbine blade support ring including an air foil extending circumferentially about said central axle structure,
a plurality of turbine blades each including an inner end supported by said central axle structure and extending outwardly from said central axle structure toward said turbine blade support ring and including an outer end supported by said turbine blade support ring,
a plurality of cables extending between said central axle structure and said turbine blade support ring and supporting said turbine blade support ring from said central axle structure such that said turbine blade support ring is rotatable about said central axle structure,
said air foil is shaped to redirect the on-coming atmospheric wind in an outwardly directed approximately conical shape extending downstream from said central axle structure for forming a reduced atmospheric air pressure downstream of said airfoil and increasing the speed of atmospheric air through the plurality of turbine blades.

8. The turbine wheel of claim 7, wherein said turbine blade support ring includes a circular perimeter rim.

9. A wind turbine including
a turbine wheel with turbine blades extending radially outwardly from a central axle structure,
a circular air foil surrounding said turbine blades and rotatable in unison with said turbine blades about said central axle structure,
said circular air foil oriented at an angle of attack with respect to the oncoming atmospheric wind for directing some of oncoming atmospheric wind outwardly to form an area of low air pressure down stream from said turbine blades that induces more rapid flow of atmospheric wind through the turbine blades.

10. The wind turbine of claim 9, and further including
a circular perimeter rim joined to said circular air foil, and
an electrical generator in engagement with said circular perimeter rim for generating electricity in response to the rotation of said turbine wheel.

11. The wind turbine of claim 9, and further including a plurality of cables extending from said central axle structure to said circular air foil for supporting said air foil from said central axle structure and for supporting the outer ends of said turbine blades.

12. The wind turbine of claim 10, wherein said circular perimeter rim includes an outwardly facing horizontal surface for engagement by an electrical generator, and a sloped forwardly facing surface extending between said airfoil and said outwardly facing horizontal surface angled to reduce the turbulence of the coming atmospheric wind passing about the circular airfoil.
